(19) United States
(12) Patent Application Publication
(10) Pub. No.: US 2024/0422036 A1
(43) Pub. Date: Dec. 19, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Naoya Shibaike, Tokyoi (JP); Satoshi Nagata, Tokyo (JP)

(73) Assignee: NTT DOCOMO, INC., Tokyo (JP)

(21) Appl. No.: 18/700,169

(22) PCT Filed: Oct. 7, 2022
(86) PCT No.: PCT/JP2022/037538

§ 371 Date: Apr. 10, 2024

(30) Foreign Application Priority Data
Oct. 14, 2021 (JP) 2021-169153

(51) Int. Cl. H04L 27/26; H04L 5/00

(52) U.S. Cl. CPC H04L 27/2607; H04L 5/0048; H04L 27/261

(57) ABSTRACT

A terminal according to one aspect of the present disclosure includes: a receiving section configured to receive a configuration related to a transmission comb of a sounding reference signal (SRS); and a control section configured to determine, based on the configuration and a bandwidth of the SRS, at least one of the number of the transmission combs, a maximum number of cyclic shifts, and a number of the cyclic shift. According to one aspect of the present disclosure, an SRS parameter can be appropriately determined.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). Furthermore, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+ (plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In a future radio communication system, a sounding reference signal (SRS) is used in a wide variety of applications. For example, SRS of NR is used not only for CSI measurement of uplink (UL) but also for CSI measurement of downlink (DL), beam management, and the like.

However, a method of determining a parameter for extending the SRS has not been studied. When the method for determining the parameter of the SRS is not clear, communication throughput or the like may deteriorate.

Therefore, an object of the present disclosure is to provide a terminal, a radio communication method, and a base station that appropriately determine an SRS parameter.

### Solution to Problem

A terminal according to one aspect of the present disclosure includes: a receiving section configured to receive a configuration related to a transmission comb of a sounding reference signal (SRS); and a control section configured to determine, based on the configuration and a bandwidth of the SRS, at least one of the number of the transmission combs, a maximum number of cyclic shifts, and a number of the cyclic shift.

### Advantageous Effects of Invention

According to one aspect of the present disclosure, an SRS parameter can be appropriately determined.

### BRIEF DESCRIPTION OF DRAWINGS

FIGS. 1A and 1B illustrate an example of a resource element used for transmission of an SRS.

FIGS. 2A and 2B illustrate another example of the resource element used for transmission of the SRS.

FIG. 3 illustrates an example of an SRS band configuration.

FIG. 4 illustrates an example of a band of SRS frequency hopping.

FIG. 5 illustrates an example of the SRS frequency hopping.

FIG. 6 illustrates another example of the SRS frequency hopping.

FIG. 7 illustrates an example of an RPFS SRS.

FIG. 8 illustrates an example of a partial band of the RPFS SRS.

FIG. 9 illustrates an example of a method 1 of determining the number of transmission combs.

FIGS. 10A and 10B illustrate an example of a configurable CS index according to the method 1 of determining the number of transmission combs.

FIG. 11 illustrates an example of a method 2 of determining the number of transmission combs.

FIG. 12 illustrates an example of a method A of determining a CS index.

FIG. 13 illustrates an example of a method B of determining the CS index.

FIGS. 14A and 14B illustrate an example of a third embodiment.

FIG. 15 illustrates an example of a method B of configuring the CS index.

FIG. 16 is a diagram illustrating an example of a schematic configuration of a radio communication system according to one embodiment.

FIG. 17 is a diagram illustrating an example of a configuration of a base station according to one embodiment.

FIG. 18 is a diagram illustrating an example of a configuration of a user terminal according to one embodiment.

FIG. 19 is a diagram illustrating an example of a hardware configuration of a base station and a user terminal according to one embodiment.

FIG. 20 is a diagram illustrating an example of a vehicle according to one embodiment.

### DESCRIPTION OF EMBODIMENTS

### (SRS)

In NR, a sounding reference signal (SRS) has a wide range of usages. The SRS of the NR is used not only for uplink (UL) CSI measurement also used in existing LTE (LTE Rel. 8 to 14) but also for downlink (DL) CSI measurement, beam management and the like.

In the UE, one or a plurality of SRS resources may be configured. The SRS resource may be specified by an SRS resource index (SRI).

Each SRS resource may include one or a plurality of SRS ports (may correspond to one or a plurality of SRS ports). For example, the number of ports of each SRS may be one, two, four and the like.

For the UE, one or more SRS resource sets may be configured. One SRS resource set may be associated with a given number of SRS resources. The UE may commonly use a higher layer parameter for the SRS resources included in one SRS resource set. It is noted that, in the present disclosure, the resource set may be interchangeable with a set, a resource group, a group, and the like.

Information on the SRS resources or resource set may be configured in the UE by using higher layer signaling, physical layer signaling, or a combination thereof.

An SRS configuration information element (for example, “SRS-Config” of an RRC information element) may include an SRS resource set configuration information element, an SRS resource configuration information element, and the like.

The SRS resource set configuration information element (for example, “SRS-ResourceSet” of an RRC parameter) may include information on an SRS resource set identifier (ID) (SRS-ResourceSetld), a list of SRS resource IDs (SRS-ResourceId) used in the resource set, an SRS resource type (resourceType), and SRS usage (usage).

Here, the SRS resource type may indicate a behavior in the time domain of an SRS resource configuration (same time domain behavior), and may indicate any one of a periodic SRS (P-SRS), a semi-persistent SRS (SP-SRS), and an aperiodic SRS (A-SRS). It is noted that the UE may transmit the P-SRS and SP-SRS periodically (or periodically after activation). The UE may transmit the A-SRS based on the SRS request of the DCI.

In addition, the application of SRS (“usage” of the RRC parameter and “SRS-SetUse” of the L1 (Layer-1) parameter) may be, for example, beam management (beamManagement), codebook (CB), non-codebook (NCB), antenna switching (antennaSwitcing), or the like. For example, an SRS used for codebook or non-codebook may be used to determine a precoder for codebook-based or non-codebook-based physical uplink shared channel (PUSCH) transmission based on an SRI.

For an SRS used for beam management, it may be assumed that only one SRS resource per SRS resource set can be transmitted at a given time instant (given time instant). It is noted that, in a case where, in the same bandwidth part (BWP), a plurality of SRS resources falling under the same behavior in the time domain belong to different SRS resource sets, these SRS resources may be simultaneously transmitted.

The SRS resource configuration information element (for example, “SRS-Resource” of the RRC parameter) may include an SRS resource ID (SRS-ResourceId), the number of SRS ports, an SRS port number, the number of transmission combs, SRS resource mapping (such as a time and/or frequency resource position, a resource offset, a resource period, the number of repetitions, the number of SRS symbols, an SRS bandwidth, and the like), hopping-related information, an SRS resource type, a sequence ID, spatial relation information, and the like.

A value of the number of transmission combs (transmissionComb) is {2,4}. A value of the number of antenna ports (nrofSRS-Ports) N_ap\hat{ }SRS is {1,2,4}. A value of an antenna port number p_i is {1000, 1001, . . . }. A value of the number of consecutive OFDM symbols (nrofSymbols) N_symb\hat{ }SRS of the SRS is {1, 2, 4}. For a starting position (startPosition) in a time domain, an offset I_offset of a symbol counted in a time domain reverse direction from an end of a slot is {0, 1, . . . 5}, and the starting position is given by I_0=N_symb\hat{ }slot-I-I_offset.

The configuration of the number of transmission combs may include a comb offset and a cyclic shift (cyclic shift (CS) index, CS number).

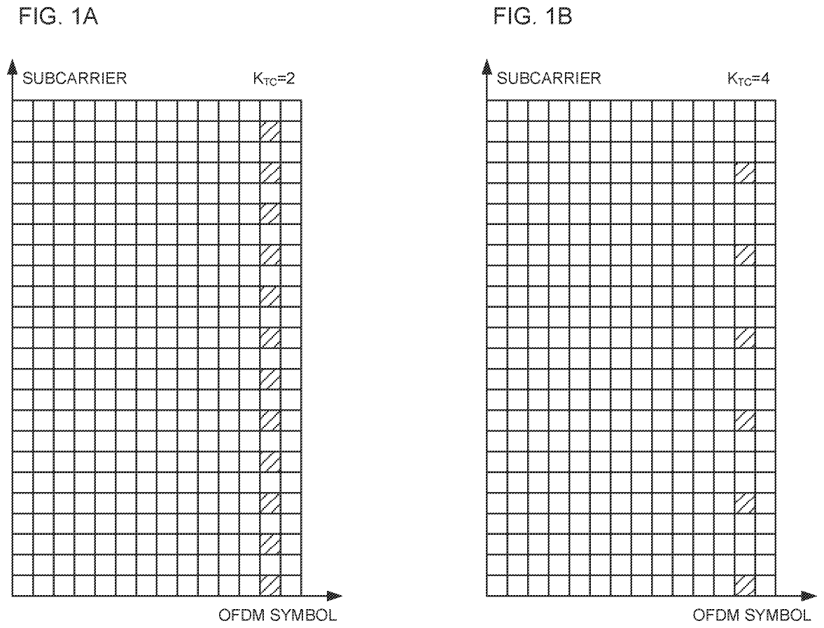

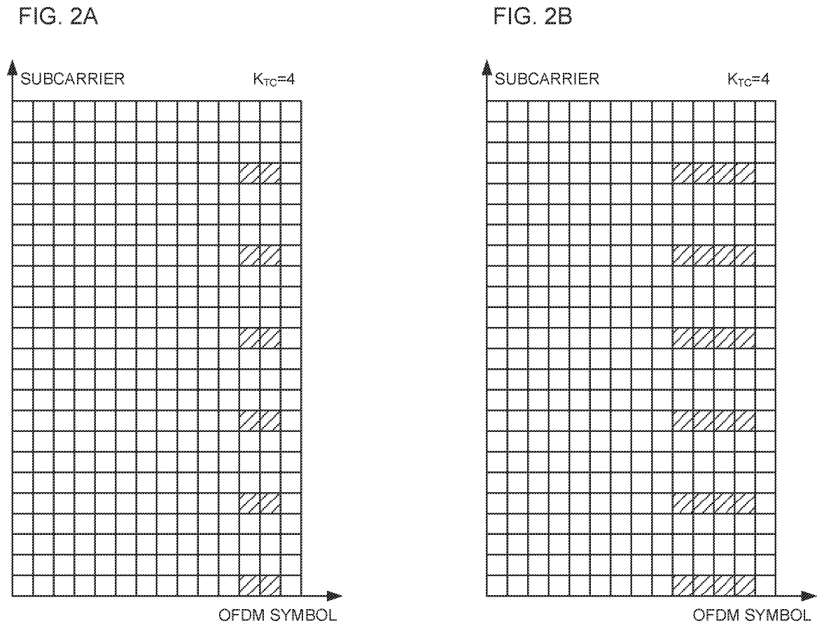

FIG. 1A illustrates a resource element used for SRS transmission with the number of transmission combs K_TC=2 and the number of symbols=1. FIG. 1B illustrates a resource element used for SRS transmission with the number of transmission combs K_TC=4 and the number of symbols=1. FIG. 2A illustrates a resource element used for SRS transmission with the number of transmission combs K_TC=4 and the number of symbols=2. FIG. 2B illustrates a resource element used for SRS transmission with the number of transmission combs K_TC=4 and the number of symbols=4. SRSs from UEs having different at least one of comb offset (subcarrier offset)={0, 1, . . . . K_TC−1} and CS may be multiplexed using the same number of transmission combs and the same RB and the same symbol.

The UE may switch a bandwidth part (BWP) to transmit an SRS or may switch antennas slot by slot. In addition, the UE may apply at least one of in-slot hopping and inter-slot hopping to the SRS transmission.

In the existing SRS, a frequency domain starting position k₀^{pi} is given by the calculation formula below.

$${k}_{0}^{p \_ i} = {k}_{0}^{- p \_ i} + {{\sum }_{b = 0}}^{BSRS} {K}_{T C} {{M}_{SC , b}}^{SRS} {n}_{b}$$

Here, k⁻ represents a variable in which k is denoted by an overline, and may also be referred to as a k bar. K⁻₀^{p_i} may be based on a comb offset. K_{Tc} is the number of transmission combs. M_{SC,b}^{SRS} is the number of subcarriers used for the SRS transmission in the SRS bandwidth m_{SRS,b} [RB]. n_{b} is a constant.

### (SRS Bandwidth Configuration)

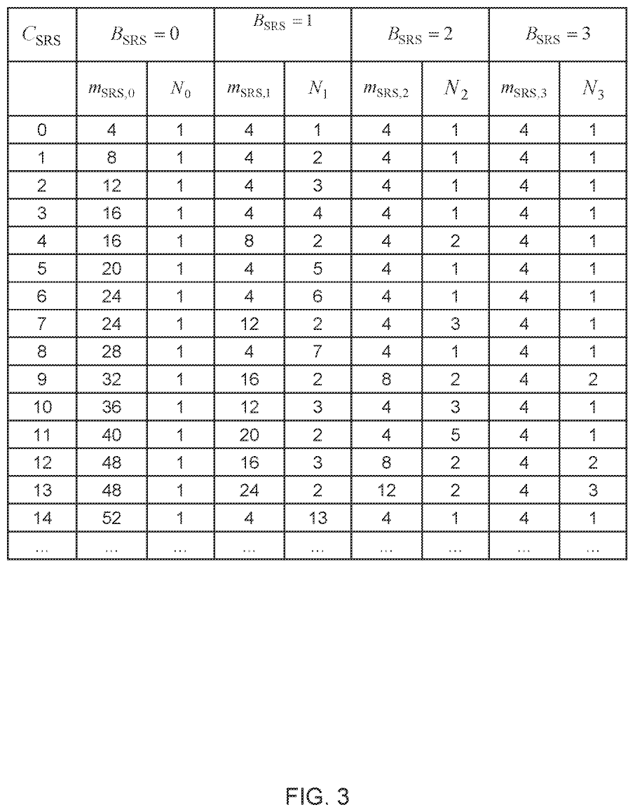

The SRS bandwidth is defined in the specifications of Rel. 16. C_{SRS}ϵ{0, . . . ,63} (configuration index, row index) and B_{SRS}ϵ{0,1,2,3} (the number of boundaries of the bandwidth division) are configured by using higher layer signaling, and the SRS bandwidth is determined by using a table (association, mapping) in FIG. 3.

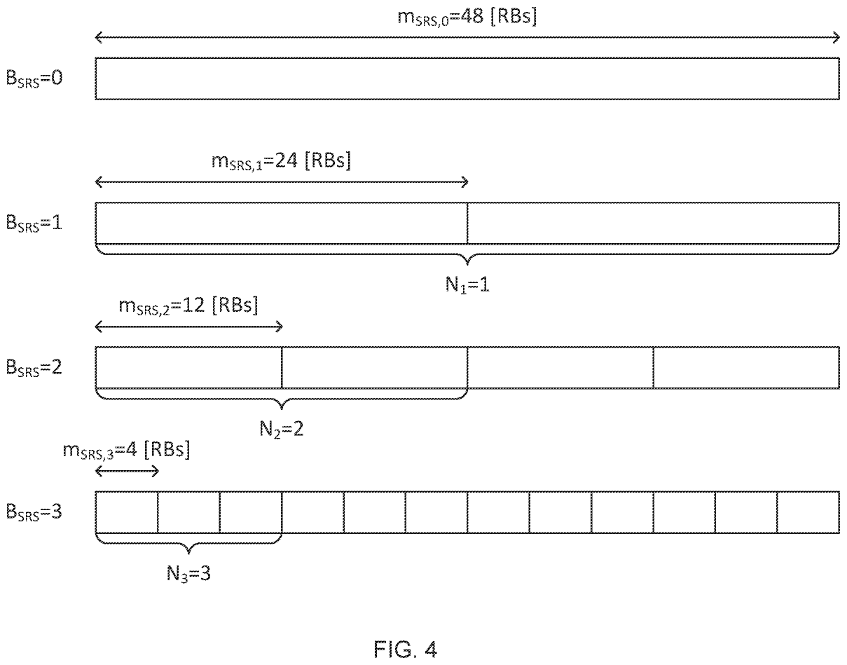

As in the example of FIG. 4, using the B_{SRS}, the available bandwidth is divided into several parts. The plurality of parts is used for SRS hopping. The C_{SRS} configures a set of SRS bands. The B_{SRS} selects one bandwidth in the configured set. This example indicates a case where C_{SRS}=13. All candidate values of an SRS bandwidth M_{SRS.b} (the number of RBs) are multiples of 4. The B_{SRS} divides the available bandwidth into a plurality of parts. The larger the B_{SRS}, the larger the number of frequency sections (the smaller the size of the frequency sections).

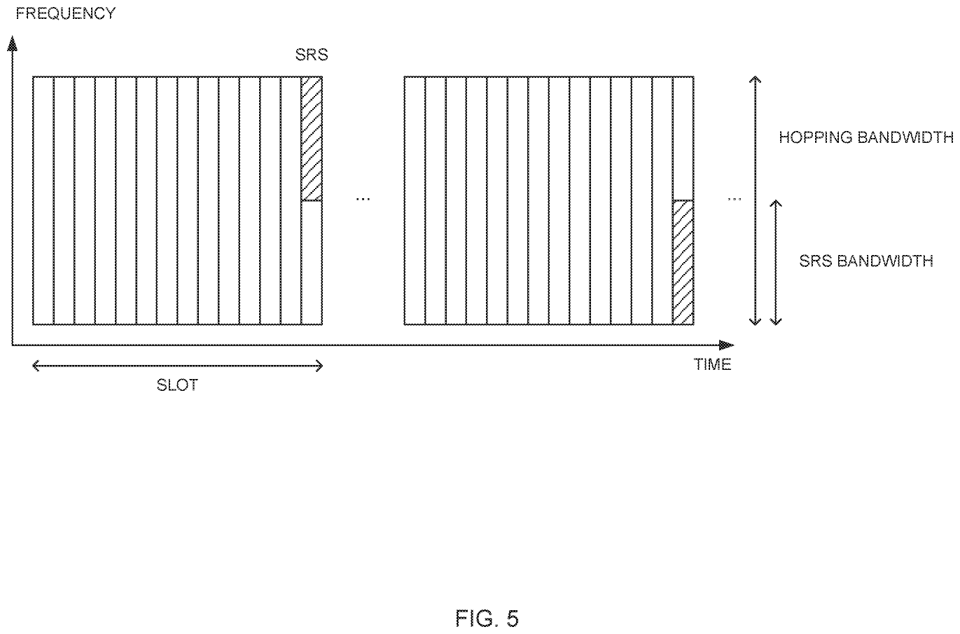

A parameter bₕₒₚϵ{0, 1,2,3} is configured for SRS frequency hopping. In the case of bₕₒₚ<B_{SRS}, SRS frequency hopping is enabled. As illustrated in the example of FIG. 5, the SRS is transmitted using the SRS band in the band (hopping band) given to the SRS frequency hopping.

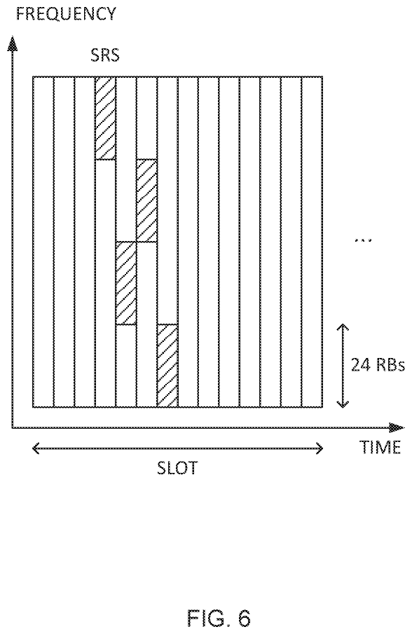

FIG. 6 illustrates an example of SRS frequency hopping when C_{SRS}=24, bₕₒₚ=0, B_{SRS}=2, and N_{symb}^{SRS}=4. In the band (hopping band) given to the SRS frequency hopping, the SRS having the SRS band m_{SRS.b} (24 RBs in this example) is transmitted.

### (Partial Frequency Sounding)

RB-level partial frequency sounding (resource block (RB)-level partial frequency sounding (RPFS), partial RB-level frequency sounding, and partial frequency sounding) using the SRS has been studied.

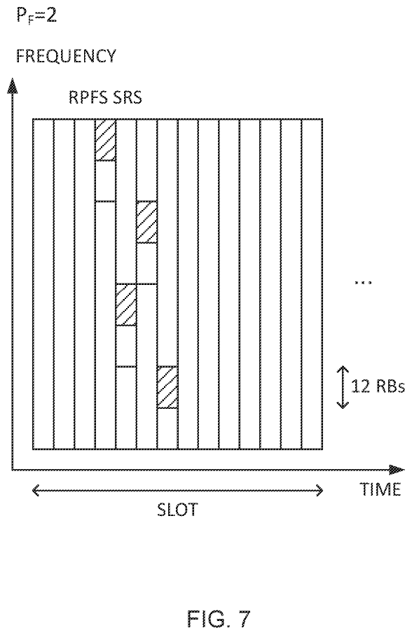

FIG. 7 illustrates an example of RPFS SRS frequency hopping in the case of the number of parts P_{F}=2 in addition to the configuration in FIG. 6. At each hop, SRS transmissions may be performed over 1/P_{F} bandwidth of the available bandwidth (12 RBs in this example).

Start RB indexes of 1/P_{F}*m_{SRS,BSRS} RBs among m_{SRS,BSRS} RBs may be given by the formula below.

N_{offset}=k_{F}/P_{F}*m_{SRS,BSRS} (Formula 1)

Here, k_{F}={0, . . . , P_{F}−1} may be satisfied.

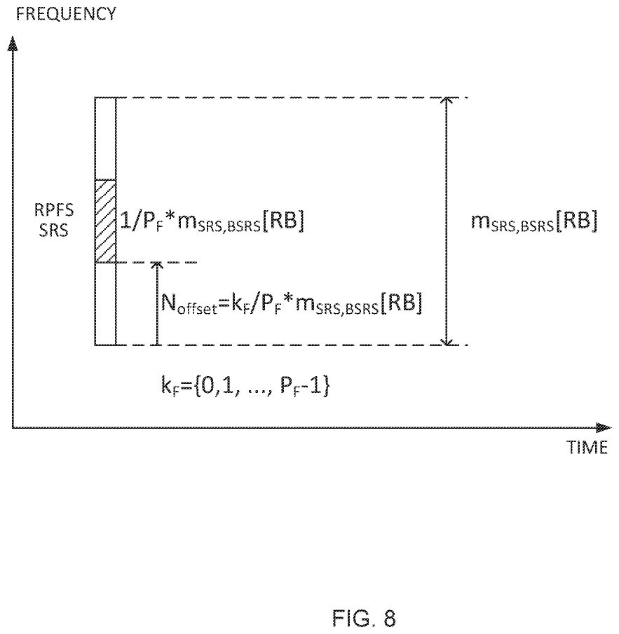

In the example of FIG. 8, the existing SRS full band m_{RS.BSRS} is divided into P_{F} partial bands (bandwidth 1/P_{F}*m_{SRS.BSRS}). A start RB index (partial band offset) of one partial band is N_{offset}.

The RPFS SRS provides a method for increasing the power per subcarrier since partial band sounding allocates the available transmission power in a section of smaller bandwidth as compared to full band sounding. Further, the SRS capacity can be enhanced by giving the network an occasion to multiplex more UE ports on the remaining frequency resources. As compared with a case where a narrow band is allocated by existing (Rel. 16) SRS transmission, it is possible to sound a wide band by using a smaller number of times.

The RPFS may support P_{F}={2,4}

At least one of Bandwidths 1 to 4 below may be supported for the bandwidth

1/P_{F}*m_{SRS.BSRS} [RB] of the RPFS.

[Bandwidth 1] 1/P_{F}*m_{SRS.BSRS} is an integer value.

[Bandwidth 2] 1/P_{F}*m_{SRS.BSRS} is an integer value of a minimum value 4.

[Bandwidth 3] 1/P_{F}*m_{SRS.BSRS} is a multiple of 4.

[Bandwidth 4] In Option 1 or 2, 1/P_{F}*m_{SRS.BSRS} is rounded to a multiple of 4 (round function, rounding).

The RPFS SRS employs Sequence Generation 1 or 2 below, and a sequence length other than the sequence length supported in the existing specifications may not be introduced.

[Sequence Generation 1] The UE generates a Zadoff-Chu (ZC) sequence having a length of 12/P_{F}*m_{SRS.BSRS}/Comb.

[Sequence Generation 2] The UE truncates the sequence of a length of 12*m_{SRS.BSRS}/Comb.

However, a method of determining at least one of the number of transmission combs and the cyclic shift of the SRS sequence is not clear. When such a method of determining an SRS parameter is not clear, communication throughput or the like may deteriorate.

Therefore, the present inventors have conceived the method of the SRS parameter.

Hereinafter, embodiments according to the present disclosure will be described in detail with reference to the drawings. The radio communication method according to each of the embodiments may be applied independently, or may be applied in combination with others.

In the present disclosure, “A/B” and “at least one of A or B” may be interchangeable with each other. Furthermore, in the present disclosure, “A/B/C” may mean “at least one of A, B, and C”.

In the present disclosure, activate, deactivate, instruct (or indicate), select, configure, update, determine, and the like may be interchangeable with each other. In the present disclosure, support, control, can control, operate, can operate, and the like may be interchangeable with each other.

In the present disclosure, radio resource control (RRC), an RRC parameter, an RRC message, an upper layer parameter, an information element (IE), a setting, and the like may be interchangeable with each other. In the present disclosure, a Medium Access Control control element (MAC control element (CE)), an update command, an activation/deactivation command, and the like may be interchangeable with each other.

In the present disclosure, the higher layer signaling may be any of, for example, radio resource control (RRC) signaling, medium access control (MAC) signaling, broadcast information, and the like, or a combination thereof.

In the present disclosure, the MAC signaling may use, for example, the MAC control element (MAC CE), a MAC protocol data unit (PDU), or the like. The broadcast information may be, for example, a master information block (MIB), a system information block (SIB), remaining minimum system information (RMSI), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeable with each other. In the present disclosure, a sequence, a list, a set, a group, a cohort, a cluster, a subset, and the like may be interchangeable with each other.

In the present disclosure, the integer values 0, 1, . . . and n0, n1, . . . may be interchangeable with each other.

### (Radio Communication Method)

In each embodiment, an SRS allocation bandwidth, an SRS bandwidth, m_{SRS,b}[RB], an SRS bandwidth to be actually transmitted, and an SRS transmission bandwidth may be interchangeable with each other. In other words, in each embodiment, the SRS allocation bandwidth may refer to an entire bandwidth of bands allocated to the SRS including a band that is not actually used for transmission, or may refer to a total bandwidth of bands that are actually used for transmission (not including bands that are not actually used for transmission by comb).

In each embodiment, the bandwidth used for the SRS transmission, the number of RBs used for the SRS transmission, the number of subcarriers used for the SRS transmission, M_{SC,b}^{SRS} [subcarriers] may be interchangeable with each other. The SRS bandwidth to be actually transmitted may be determined based on at least one of whether frequency hopping is applied and whether the foregoing RB-level partial frequency sounding is applied.

In each embodiment, a CS index, a CS number, a CS value, n_SRS\hat{ }cs, and n_SRS\hat{ }cs,i may be interchangeable with each other.

In each embodiment, the SRS sequence may be a low peak-to-average power ratio (PAPR) sequence defined by a cyclic shift (CS) α_i of base sequence. α_i may be given by 2π*n_SRS\hat{ }cs,i/n_SRS\hat{ }cs, max using the CS index n_SRS\hat{ }cs,i and the maximum number of CSs n_SRS\hat{ }cs, max. n_SRS\hat{ }cs,i may be {0, 1, . . . n_SRS\hat{ }cs, max-1} based on the CS indexes n_SRS\hat{ }cs, n_SRS\hat{ }cs, max, the antenna port number p_i, and the number of antenna ports N_ap\hat{ }SRS. The CS index n_SRS\hat{ }cs or n_SRS\hat{ }cs,i may be configured by higher layer signaling or may be included in the transmission comb configuration (higher layer parameter transmissionComb).

In each embodiment, the transmission comb configuration, the transmissionComb, and the number of transmission combs may be interchangeable with each other. In each embodiment, the transmission comb configuration may include at least one of the number of transmission combs (K_TC), the comb offset (starting subcarrier offset), and the CS index.

### First Embodiment

This embodiment relates to the number of transmission combs (transmissionComb).

A value 8 (comb 8, n8) of the number of transmission combs may be specified in the specification. This improves capacity/UE multiplexing capacity.

In Rel. 15, a minimum bandwidth of the SRS is 4 PRBs, and the SRS bandwidth is a multiple of 4 PRBs greater than or equal to 4 PRBs. When the SRS uses 4 PRBs and comb 8, the bandwidth to be actually transmitted (SRS sequence length) is 12 subcarriers*4 PRBs/comb 8=6 subcarriers, and only 6 CSs are available. When comb 8 and 6 CSs are used, the UE multiplexing number (UE multiplexing capacity) is the same (48) as that of a case in which comb 4 and 12 CSs are used. Therefore, when the number of CSs in the case of comb 8 is limited to six (the maximum number of CSs n_SRS\hat{ }cs, max is 6), the UE multiplexing capacity cannot be improved.

When the SRS bandwidth is greater than 4 PRBs (is a multiple of 4 PRBs), for example, when comb 8 and 8 PRBs are used, the bandwidth to be actually transmitted (SRS sequence length) is 12 subcarriers*8 PRBs/comb 8=12 subcarriers, and 12 CSs can be used. The maximum number of CSs may be 12 or more. The UE multiplexing capacity in this case is 96, and the UE multiplexing capacity can be improved as compared with a case in which comb 4 and 12 CSs are used. Similarly, when the SRS bandwidth is wider than 8 PRBs, the UE multiplexing capacity can be improved as compared with the case in which comb 4 and 12 CSs are used.

According to this embodiment, it is possible to improve the number (capacity) of UEs that multiplex the SRS.

### Second Embodiment

The maximum number of CSs may be different depending on the SRS allocation bandwidth.

The UE may follow at least one of the following methods 1 and 2 of determining the number of transmission combs.

### <<Method 1 of Determining the Number of Transmission Combs>>

A correspondence relationship between the number of transmission combs to be configured by the higher layer signaling and the number of transmission combs to be actually applied (transmission comb configuration) may be defined in the specification. The number of transmission combs to be actually applied may be defined in the specification according to the configured number of transmission combs and the value or range of the SRS allocation bandwidth.

Regarding the number of transmission combs to be configured, a first number of transmission combs in a case where the SRS allocation bandwidth is a specific bandwidth and a second number of transmission combs in a case where the SRS allocation bandwidth is not the specific bandwidth may be defined in the specification. The specific bandwidth may be 4 PRBs or may be wider than 4 PRBs. The UE may use the first number of transmission combs in a case where the SRS allocation bandwidth is the specific bandwidth, and may use the second number of transmission combs in a case where the SRS allocation bandwidth is not the specific bandwidth.

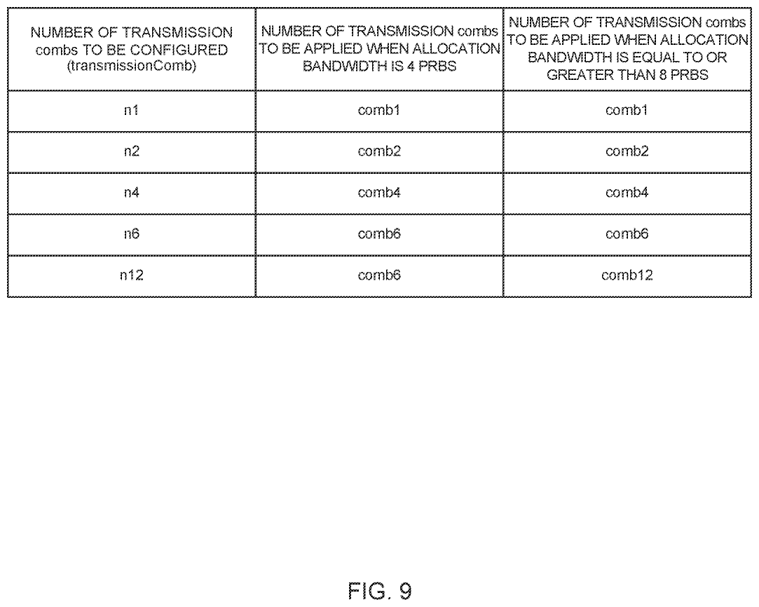

As in the example of FIG. 9, the first number of transmission combs in a case where the SRS allocation bandwidth is 4 PRBs and the first number of transmission combs in a case where the SRS allocation bandwidth is 8 PRBs or more may be defined for each of the number of transmission combs {1, 2, 4, 6, 12} to be configured.

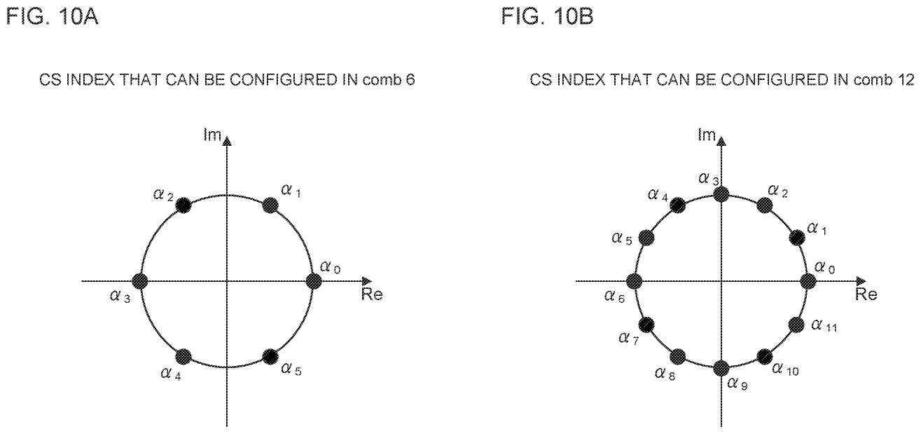

As in the example of FIG. 10A, when the number of transmission combs 6 is applied, one value of the CS index {0, 1, . . . , 5} may be configured (in the SRS resource/transmission comb configuration). As in the example of FIG. 10B, when the number of transmission combs 12 is applied, one value of the CS index {0, 1, . . . , 11} may be configured (in the SRS resource/transmission comb configuration).

### <<Method 2 of Determining the Number of Transmission Combs>>

A plurality of sets of transmission comb configurations may be configured by higher layer signaling.

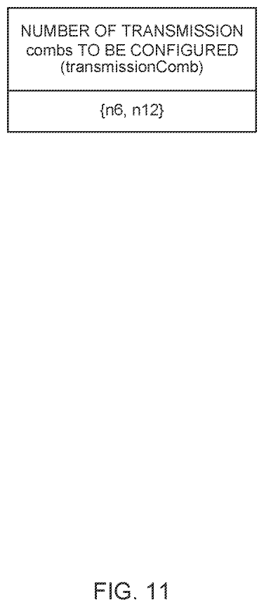

As in the example of FIG. 11, two transmission comb configurations may be configured (in the SRS resource), a first transmission comb configuration may indicate the number of transmission combs 6 (n6), and a second transmission comb configuration may indicate the number of transmission combs 12 (n12).

As in the previous example of FIG. 10, the first transmission comb configuration may include one value of the CS index {0, 1, . . . , 5} and the first transmission comb configuration may include one value of the CS index {0, 1, . . . , 11}.

For example, a transmission comb configuration for a specific bandwidth and a transmission comb configuration for other bandwidths may be configured. For example, the specific bandwidth may be 4 PRBs or may be wider than 4 PRBs. The UE may use the first transmission comb configuration when the SRS allocation bandwidth is the specific bandwidth, and use the second transmission comb configuration when the SRS allocation bandwidth is not the specific bandwidth.

Preferably, when the maximum number of CSs is 6, one value of the CS index {0, 1, . . . , 5} is instructed, and when the maximum number of CSs is 12, one value of the CS index {0, 1, . . . , 11} is instructed.

In the method 1/2 of determining the number of transmission combs, the maximum number of CSs may be different depending on the SRS allocation bandwidth, and the range or the value of the CS index may be determined depending on the maximum number of CSs.

The UE may determine, from the configured CS index, the CS index to be actually applied according to the SRS allocation bandwidth. An association between a plurality of configurable CS indexes and a plurality of applicable CS indexes may be defined in the specification, or may be configured by higher layer signaling.

A cyclic shift a of the SRS sequence may be 2π×CS index/the maximum number of CSs, or may be 2π×index/the maximum number of CSs by using an index based on the CS index.

The UE may follow at least one of the following methods A and B of determining the CS index.

### <<Method a of Determining CS Index>>

The number of applicable CS indexes may be less than or equal to the number of configurable CS indexes. When the number of configurable CS indexes is equal to the maximum number of CSs based on the SRS allocation bandwidth, the UE may apply the configured CS index.

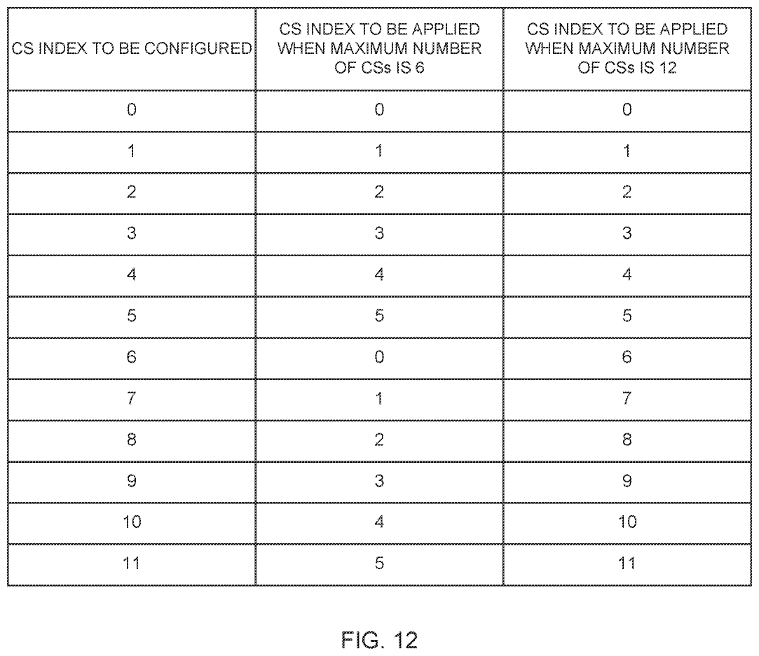

One value of the CS index {0, 1, . . . , 11} may be configured. In the example of FIG. 12, with respect to the CS index {0, 1, . . . , 11} to be configured, a CS index {0, 1, . . . , 5, 0, 1, . . . , 5} to be applied in a case where the maximum number of CSs is 6 (the SRS allocation bandwidth is 4 PRBs) and a CS index {0, 1, . . . , 11} to be applied in a case where the maximum number of CSs is 12 are associated with each other. The number of configurable CS indexes is not limited to 12, and may be other numbers. The number of applicable CS indexes is not limited to 6 and 12, and may be other numbers.

The CS index to be configured may be less than the maximum number of CSs. It may be stipulated that the UE does not assume that CS indexes greater than or equal to the maximum number of CSs are configured. For example, when the maximum number of CSs is 6 (the SRS allocation bandwidth is 4 PRBs), the CS indexes 6 to 11 may not be configured.

### <<Method B of Determining CS Index>>

The number of applicable CS indexes may be greater than or equal to the number of configurable CS indexes. When the number of configurable CS indexes is equal to the maximum number of CSs based on the SRS allocation bandwidth, the UE may apply the configured CS index.

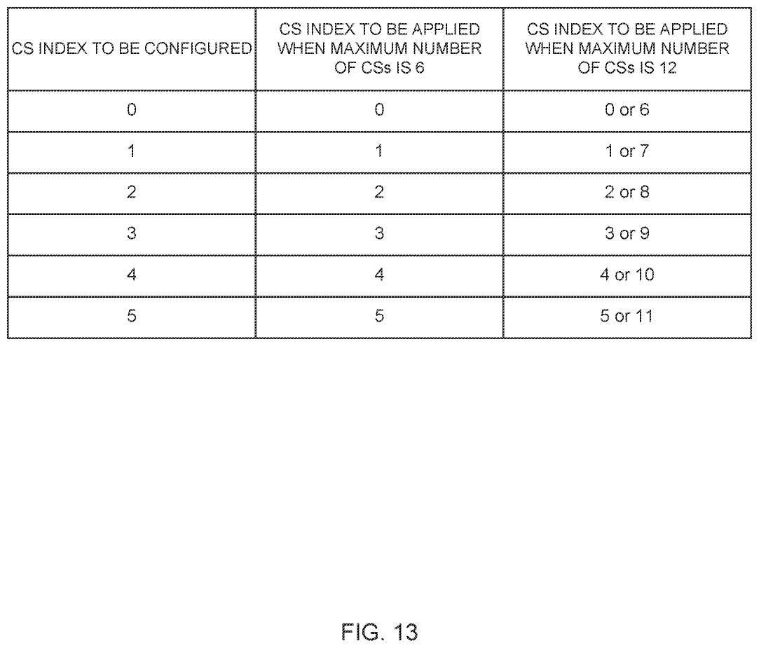

One value of the CS index {0, 1, . . . , 5} may be configured. In the example of FIG. 13, with respect to the CS index {0, 1, . . . , 5} to be configured, a CS index {0, 1, . . . , 5} to be applied in a case where the maximum number of CSs is 6 and a CS index {0 or 6, 1 or 7, . . . , 5 or 11} to be applied in a case where the maximum number of CSs is 12 are associated with each other. The number of configurable CS indexes is not limited to 6, and may be other numbers. The number of applicable CS indexes is not limited to 6 and 12, and may be other numbers.

For example, when the CS index to be configured is 0 and the maximum number of CSs is 12, the UE may determine, based on a rule, whether the CS index to be applied is 0 or 6, or may determine, based on an instruction of higher layer signaling/DCI. For example, the rule may determine the CS index to be applied based on the CS index to be configured/SRS resource (PRB index/comb offset/symbol index)/port number/the number of ports.

According to this embodiment, the number of combs and the maximum number of CSs can be appropriately configured according to the SRS transmission bandwidth.

### Third Embodiment

The maximum number of CSs may be equal regardless of the SRS allocation bandwidth.

The range of configurable (available) CS indexes may be different depending on the SRS allocation bandwidth.

A cyclic shift a of the SRS sequence may be 2π×CS index/the maximum number of CSs, or may be 2π×index/the maximum number of CSs by using an index based on the CS index.

For example, in the case of the maximum number of CSs, the CS index may follow at least one of the following methods A and B of configuring the CS index.

### <<Method A of Configuring CS Index>>

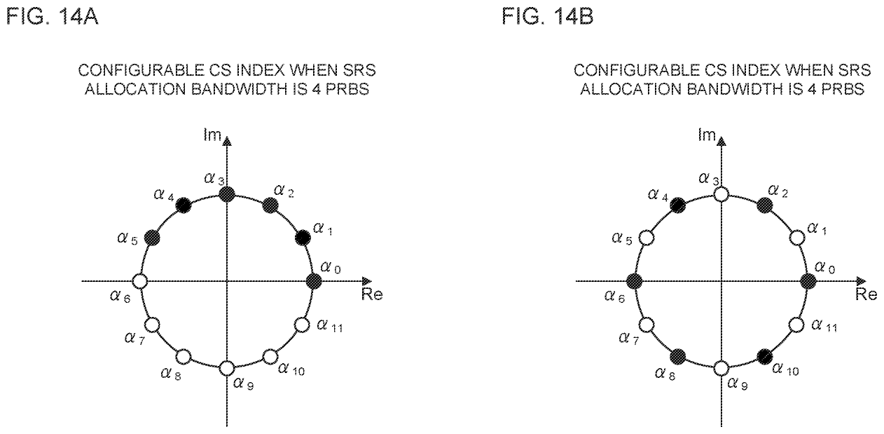

When the SRS allocation bandwidth is 4 PRBs, as in the example of FIG. 14A, the CS index that can be configured/instructed/used may be {0, 1, . . . , 5}. When the SRS allocation bandwidth is 8 PRBs, the CS index that can be configured/instructed/used may be {0, 1, . . . , 11}.

### <<Method B of Configuring CS Index>>

When the SRS allocation bandwidth is 4 PRBs, as in the example of FIG. 14B, the CS index that can be configured/instructed/used may be {0,2,4,6,8,10}. When the SRS allocation bandwidth is 8 PRBs, the CS index that can be configured/instructed/used may be {0, 1, . . . , 11}.

When there is no frequency selective fading, a correlation between two sequences based on two adjacent CS indexes is 0. When the frequency selective fading increases, the correlation between two sequences based on the two adjacent CS indexes increases, interference occurs, and characteristics deteriorates. According to the method B of configuring the CS index, even when the SRS allocation bandwidth is 4 PRBs, an interval between the adjacent CS indexes (an angle between the adjacent CSs) can be maximized, thereby having reliable characteristics.

The UE may determine, from the configured CS index, the CS index to be actually applied according to the SRS allocation bandwidth. An association between a plurality of configurable CS indexes and a plurality of applicable CS indexes may be defined in the specification, or may be configured by higher layer signaling.

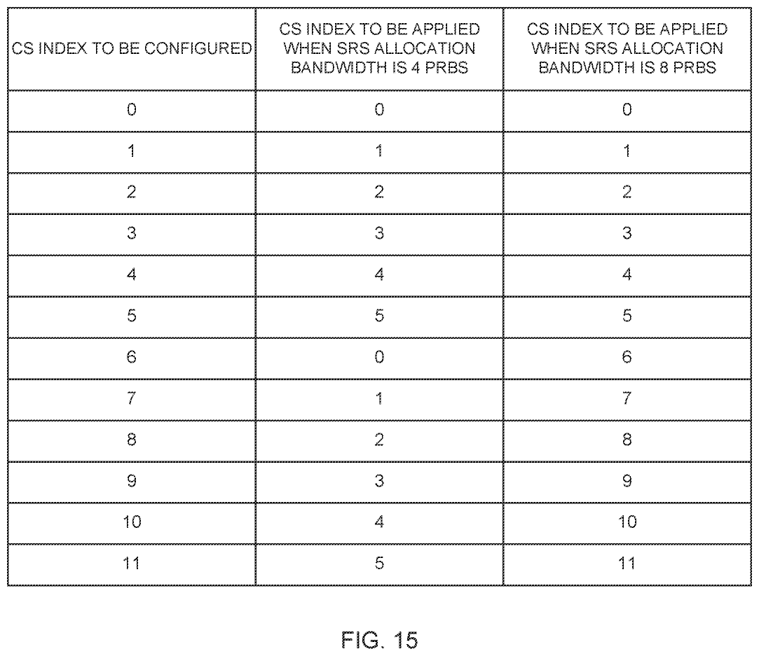

One value of the CS index {0, 1, . . . , 11} may be configured. In the example of FIG. 15, with respect to the CS index {0, 1, . . . , 11} to be configured, a CS index {0, 2, 4, 6, 8, 10, 0, 2, 4, 6, 8, 10} to be applied in a case where the SRS allocation bandwidth is 4 PRBs and a CS index {0, 1, . . . , 11} to be applied in a case where the SRS allocation bandwidth is 8 PRBs or more are associated with each other. The number of configurable CS indexes is not limited to 12, and may be other numbers. The number of applicable CS indexes is not limited to 6 and 12, and may be other numbers. The value of the applicable CS index is not limited to this example, and may be other values.

According to this example, both when the SRS allocation bandwidth is 4 PRBs and when the same is 8 PRBs or more, the same candidate for the value of the CS index can be configured, and the UE can apply the appropriate CS index.

The CS index to be configured may be smaller than the number of applicable CS indexes. It may be stipulated that the UE does not assume that CS indexes greater than or equal to the number of applicable CS indexes are configured. For example, when the SRS allocation bandwidth is 4 PRBs, the CS indexes 6 to 11 may not be configured.

According to this embodiment, the CS can be appropriately configured according to the SRS transmission bandwidth.

### OTHER EMBODIMENTS

### <<UE Capability Information/Higher Layer Parameter>>

A higher layer parameter (RRC IE)/UE capability corresponding to a function (feature) in each of the above embodiments may be defined. The higher layer parameter may indicate whether the function is activated. The UE capability may indicate whether the UE supports the function.

The UE in which the higher layer parameter corresponding to the function is configured may perform the function. “The UE in which the higher layer parameter corresponding to the function is not configured does not perform the function (for example, according to Rel. 15/16)” may be defined.

The UE that has reported/transmitted the UE capability indicating support for the function may perform the function. “The UE that does not report the UE capability indicating support for the function does not perform the function (for example, according to Rel. 15/16)” may be defined.

When the UE reports/transmits the UE capability indicating the support for the function, and a higher layer parameter corresponding to the function is configured, the UE may perform the function. “When the UE does not report/transmit the UE capability indicating the support for the function or the higher layer parameter corresponding to the function is not configured, the UE does not perform the function (for example, according to Rel. 15/16)” may be defined.

Among the foregoing plurality of embodiments, which embodiment/option/choice/function is used may be configured by higher layer parameters, may be reported by the UE as UE capability, may be defined in the specifications, or may be determined by the reported UE capability and the configuration of the higher layer parameters.

The UE capability may indicate whether to support at least one of the following functions.
Comb 8 (the number of transmission combs=8).
Maximum number of CSs for comb 8=6.
Maximum number of CSs for comb 8=12.

According to the above UE capability/higher layer parameters, the UE can realize the above functions while maintaining compatibility with existing specifications.

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

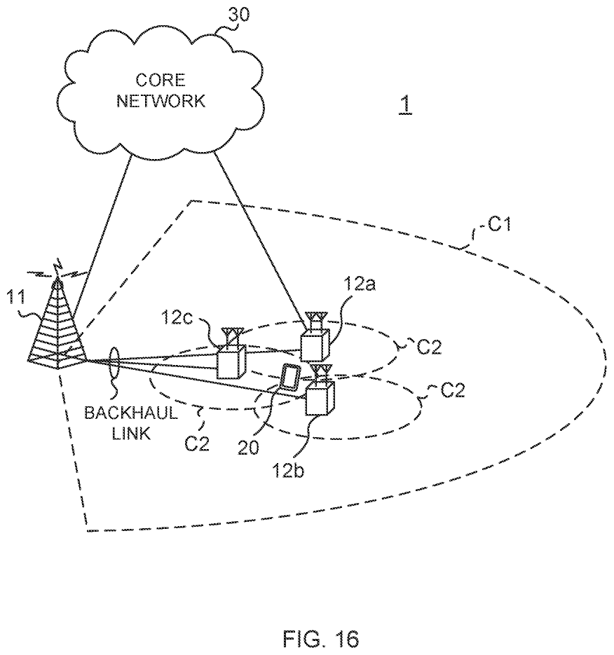

FIG. 16 is a diagram illustrating an example of a schematic configuration of a radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency band (frequency range 1 (FR1)) or a second frequency band (frequency range 2 (FR2)). The macro cell C1 may be included in the FR1, and the small cell C2 may be included in the FR2. For example, the FR1 may be a frequency band of 6 GHz or less (sub-6 GHZ), and the FR2 may be a frequency band higher than 24 GHZ (above-24 GHz). It is noted that the frequency bands, definitions, and the like of the FR1 and FR2 are not limited thereto, and, for example, the FR1 may correspond to a frequency band higher than the FR2.

Further, the user terminal 20 may perform communication on each CC using at least one of time division duplex (TDD) and frequency division duplex (FDD).

The plurality of base stations 10 may be connected to each other in a wired manner (for example, an optical fiber, an X2 interface, or the like in compliance with common public radio interface (CPRI)) or in a radio manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), or the like.

The user terminal 20 may be a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. It is noted that in the radio communication system 1, another radio access method (for example, another single carrier transmission method or another multi-carrier transmission method) may be used as the UL and DL radio access method.

In the radio communication system 1, a downlink shared channel (physical downlink shared channel (PDSCH)) shared by the user terminals 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by the user terminals 20, an uplink control channel (physical uplink control channel (PUCCH)), a random access channel (physical random access channel (PRACH)), and the like may be used as uplink channels.

User data, higher layer control information, a system information block (SIB), and the like are transmitted on the PDSCH. The user data, higher layer control information, and the like may be transmitted on the PUSCH. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH and the PUSCH.

It is noted that the DCI that schedules the PDSCH may be referred to as DL assignment, DL DCI, or the like, and the DCI that schedules PUSCH may be referred to as UL grant, UL DCI, or the like. It is noted that the PDSCH may be interchangeable with DL data, and the PUSCH may be interchangeable with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. UE may monitor CORESET associated with a certain search space based on search space configuration.

One search space may correspond to a PDCCH candidate corresponding to one or more aggregation levels. One or more search spaces may be referred to as a search space set. It is noted that “search space”, “search space set”, “search space configuration”, “search space set configuration”, “CORESET”, “CORESET configuration”, and the like in the present disclosure may be interchangeable with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), and scheduling request (SR) may be transmitted on the PUCCH. A random access preamble for establishing connection with a cell may be transmitted on the PRACH.

It is noted that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS block (SSB), or the like. It is noted that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). It is noted that, the DMRSs may be referred to as “user terminal-specific reference signals (UE-specific reference signals)”.

### (Base Station)

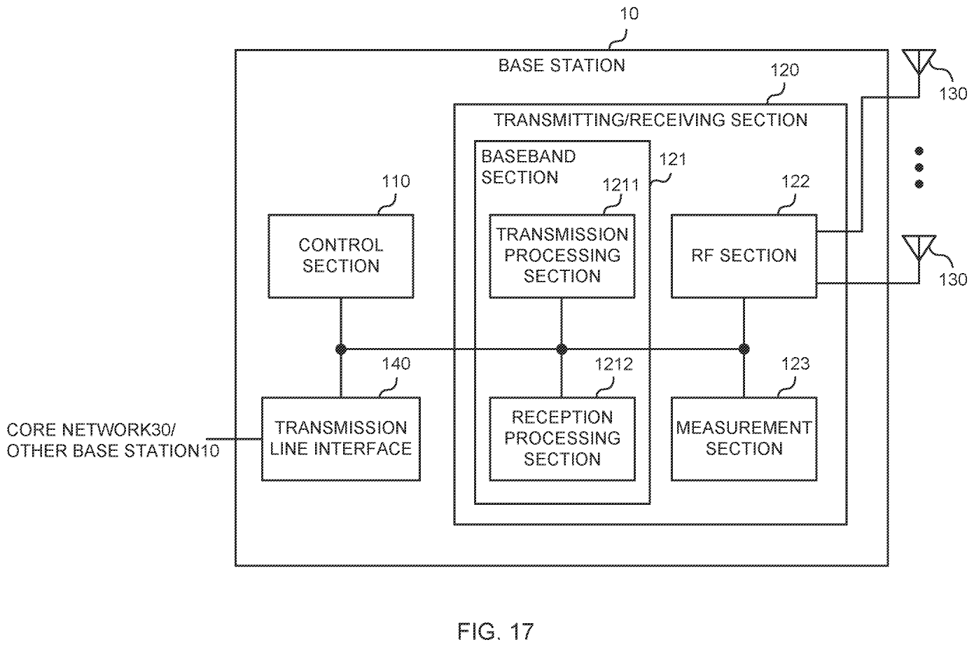

FIG. 17 is a diagram illustrating an example of a configuration of the base station according to one embodiment. The base station 10 includes a control section 110, a transmitting/receiving section 120, a transmitting/receiving antenna 130, and a transmission line interface 140. It is noted that one or more of the control sections 110, one or more of the transmitting/receiving sections 120, one or more of the transmitting/receiving antennas 130, and one or more of the transmission line interfaces 140 may be included.

It is noted that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be constituted by a controller, a control circuit, or the like, which is described based on common recognition in the technical field to which the present disclosure relates.

The control section 110 may control signal generation, scheduling (for example, resource allocation or mapping), and the like. The control section 110 may control transmission/reception, measurement, and the like using the transmitting/receiving section 120, the transmitting/receiving antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can be constituted by a transmitter/receiver, an RF circuit, a baseband circuit, a filter, a phase shifter, a measurement circuit, a transmission/reception circuit, and the like, which are described based on common recognition in the technical field to which the present disclosure relates.

The transmitting/receiving section 120 may be constituted as an integrated transmitting/receiving section, or may be constituted by a transmitting section and a receiving section. The transmitting section may include the transmission processing section 1211 and the RF section 122. The receiving section may be constituted by the reception processing section 1212, the RF section 122, and the measurement section 123.

The transmitting/receiving antenna 130 can be constituted by an antenna described based on common recognition in the technical field to which the present disclosure relates, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam or a reception beam using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency band, filtering processing, amplification, and the like on the baseband signal, and may transmit a signal in the radio frequency band via the transmitting/receiving antenna 130.

Meanwhile, the transmitting/receiving section 120 (RF section 122) may perform amplification, filtering processing, demodulation to a baseband signal, and the like on the signal in the radio frequency band received by the transmitting/receiving antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM) measurement, channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. A measurement result may be output to the control section 110.

The transmission line interface 140 may transmit/receive a signal (backhaul signaling) to and from an apparatus included in the core network 30, another base stations 10, and the like, and may acquire, transmit, and the like user data (user plane data), control plane data, and the like for the user terminal 20.

It is noted that, the transmitting section and the receiving section of the base station 10 in the present disclosure may include at least one of the transmitting/receiving section 120, the transmitting/receiving antenna 130, and the transmission line interface 140.

The transmitting/receiving section 120 may transmit a configuration related to the transmission comb of the sounding reference signal (SRS). The control section 110 may control the reception of the SRS. At least one of the number of transmission combs, the maximum number of cyclic shifts, and a number of the cyclic shift may be determined based on the configuration and a bandwidth of the SRS.

### (User Terminal)

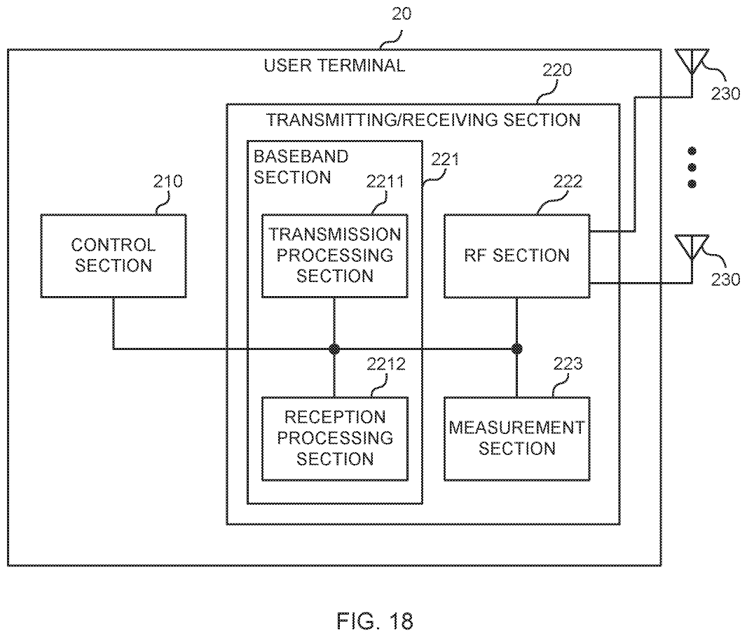

FIG. 18 is a diagram illustrating an example of a configuration of the user terminal according to one embodiment. The user terminal 20 includes a control section 210, a transmitting/receiving section 220, and a transmitting/receiving antenna 230. It is noted that one or more of the control sections 210, one or more of the transmitting/receiving sections 220, and one or more of the transmitting/receiving antennas 230 may be included.

It is noted that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described based on common recognition in the technical field related to the present disclosure.

The control section 210 may control signal generation, mapping, and the like. The control section 210 may control transmission/reception, measurement, and the like using the transmitting/receiving section 220 and the transmitting/receiving antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can include a transmitter/receiver, an RF circuit, a baseband circuit, a filter, a phase shifter, a measurement circuit, a transmission/reception circuit, and the like that are described based on common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may be configured by the reception processing section 2212, the RF section 222, and the measurement section 223.

The transmitting/receiving antenna 230 can include an antenna that is described based on common recognition in the technical field related to the present disclosure, for example, an array antenna or the like.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data, control information, and the like acquired from the control section 210, to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

It is noted that whether to apply DFT processing may be determined based on configuration of transform precoding. In a case where transform precoding is enabled for a certain channel (for example, PUSCH), the transmitting/receiving section 220 (transmission processing section 2211) may perform DFT processing as the transmission processing in order to transmit the channel using a DFT-s-OFDM waveform, and otherwise, DFT processing need not be performed as the transmission processing.

The transmitting/receiving section 220 (RF section 222) may perform modulation to a radio frequency band, filtering processing, amplification, and the like on the baseband signal, to transmit a signal in the radio frequency band via the transmitting/receiving antenna 230.

Meanwhile, the transmitting/receiving section 220 (RF section 222) may perform amplification, filtering processing, demodulation to a baseband signal, and the like on the signal in the radio frequency band received by the transmitting/receiving antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. A measurement result may be output to the control section 210.

It is noted that the transmitting section and the receiving section of the user terminal 20 in the present disclosure may include at least one of the transmitting/receiving section 220 and the transmitting/receiving antenna 230.

The transmitting/receiving section 220 may receive a configuration related to the transmission comb of the sounding reference signal (SRS). The control section 210 may determine, based on the configuration and a bandwidth of the SRS, at least one of the number of transmission combs, the maximum number of cyclic shifts, and a number of the cyclic shift.

The number of transmission combs and the maximum number of cyclic shifts may depend on the bandwidth.

The maximum number of cyclic shifts may not depend on the bandwidth.

The number of the cyclic shift may depend on the bandwidth.

### (Hardware Configuration)

It is noted that the block diagrams that have been used to describe the above embodiments illustrate blocks in functional units. These functional blocks (components) are implemented in arbitrary combinations of at least one of hardware and software. Further, the method of implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional blocks may be implemented by combining software with the above-described single apparatus or the above-described plurality of apparatuses.

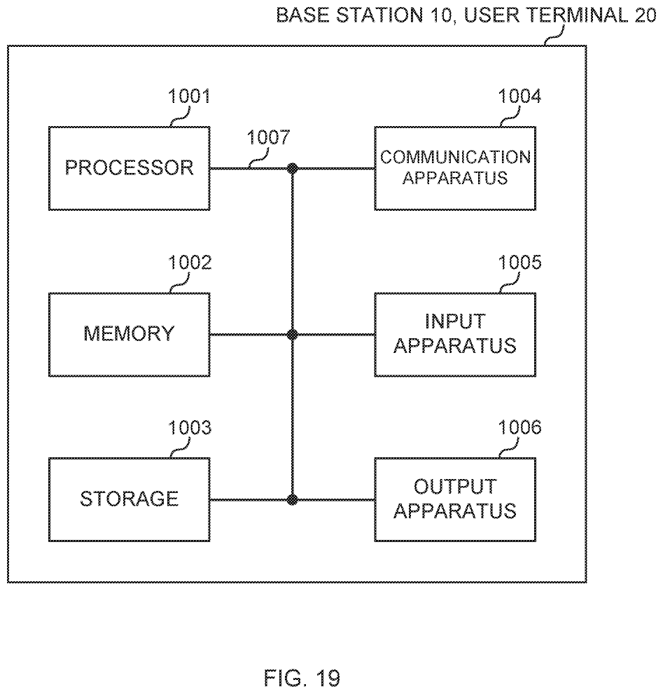

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited. For example, the base station, the user terminal, and the like according to one embodiment of the present disclosure may function as a computer that executes the processing of the radio communication method of the present disclosure. FIG. 19 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

It is noted that in the present disclosure, the terms such as an apparatus, a circuit, a device, a section, and a unit can be interchangeable with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be included. Further, the processing may be executed by one processor, or the processing may be executed by two or more processors simultaneously or sequentially, or using other methods. It is noted that the processor 1001 may be implemented by one or more chips.

Each function of the base station 10 and the user terminal 20 is implemented by given software (program) being read on hardware such as the processor 1001 and the memory 1002, by which the processor 1001 performs operations, controlling communication via the communication apparatus 1004, and controlling at least one of reading and writing of data at the memory 1002 and the storage 1003.

The processor 1001 controls the entire computer by, for example, operating an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

The processor 1001 reads programs (program codes), software modules, data, and the like from at least one of the storage 1003 and the communication apparatus 1004 into the memory 1002, and performs various types of processing according to these. As the program, a program that causes a computer to execute at least a part of the operations described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), and other appropriate storage media. The memory 1002 may be referred to as a register, a cache, a main memory (primary storage apparatus), and the like. The memory 1002 can store programs (program codes), software modules, and the like that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, and other appropriate storage media. The storage 1003 may be referred to as a “secondary storage apparatus”.

The communication apparatus 1004 is hardware (transmission/reception device) for performing inter-computer communication via at least one of a wired network and a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) and time division duplex (TDD). For example, the transmitting/receiving section 120 (220), the transmitting/receiving antenna 130 (230), and the like described above may be implemented by the communication apparatus 1004. The transmitting/receiving section 120 (220) may be implemented by physically or logically separating the transmitting section 120a (220a) and the receiving section 120b (220b) from each other.

The input apparatus 1005 is an input device for receiving input from the outside (for example, a keyboard, a mouse, a microphone, a switch, a button, a sensor, and the like). The output apparatus 1006 is an output device that performs output to the outside (for example, a display, a speaker, a light emitting diode (LED) lamp, or the like). It is noted that the input apparatus 1005 and the output apparatus 1006 may be an integrated configuration (for example, touch panel).

The apparatuses such as the processor 1001 and the memory 1002 are connected by the bus 1007 for communicating information. The bus 1007 may be formed using a single bus, or may be formed using different buses for each apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented using at least one of these pieces of hardware.

### (Modifications)

It is noted that terms described in the present disclosure and terms necessary for understanding the present disclosure may be replaced with terms that have the same or similar meanings. For example, a channel, a symbol, and a signal (signal or signaling) may be interchangeable with one another. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may include one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission and reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, and specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, the slot may be a time unit based on numerology.

The slot may include a plurality of mini slots. Each mini slot may include one or more symbols in the time domain. Further, the mini slot may be referred to as a sub-slot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) transmitted using a mini slot may be referred to as PDSCH (PUSCH) mapping type B.

A radio frame, a subframe, a slot, a mini slot, and a symbol each represent a time unit in signal transmission. The radio frame, the subframe, the slot, the mini slot, and the symbol may be called by other applicable names, respectively. It is noted that time units such as a frame, a subframe, a slot, a mini slot, and a symbol in the present disclosure may be interchangeable with each other.

For example, one subframe may be referred to as TTI, a plurality of consecutive subframes may be referred to as TTI, or one slot or one mini slot may be referred to as TTI. That is, at least one of the subframe and the TTI may be a subframe (1 ms) in the existing LTE, may be a period shorter than 1 ms (for example, one to thirteen symbols), or may be a period longer than 1 ms. It is noted that a unit representing a TTI may be referred to as a slot, a mini slot, or the like instead of a subframe.

Here, a TTI refers to, for example, a minimum time unit of scheduling in radio communication. For example, in the LTE system, a base station performs scheduling to allocate radio resources (a frequency bandwidth, transmit power, and the like that can be used in each user terminal) to each user terminal in TTI units. It is noted that the definition of a TTI is not limited to this.

A TTI may be a transmission time unit of a channel-coded data packet (transport block), a code block, a codeword, and the like or may be a processing unit of scheduling, link adaptation, and the like It is noted that, when a TTI is given, a time interval (for example, the number of symbols) to which a transport block, a code block, a codeword, or the like is actually mapped may be shorter than the TTI.

It is noted that, when one slot or one mini slot is referred to as a TTI, one or more TTIs (that is, one or more slots or one or more mini slots) may be a minimum time unit of scheduling. The number of slots (the number of mini slots) constituting the minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

It is noted that, a long TTI (such as a usual TTI or a subframe) may be replaced with a TTI having a time duration exceeding 1 ms. A short TTI (such as a shortened TTI) may be replaced with a TTI having a TTI length less than the TTI length of a long TTI and more than or equal to 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

An RB may include one or more symbols in the time domain, and may have a length of one slot, one mini slot, one subframe, or one TTI. One TTI, one subframe, and the like may each include one or more resource blocks.

It is noted that one or more RBs may be referred to as a physical resource block (PRB), a subcarrier group (SCG), a resource element group (REG), a PRB pair, an RB pair, and the like.

Furthermore, a resource block may include one or more resource elements (REs). For example, one RE may be a radio resource domain of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE does not have to assume transmission/reception of a given signal/channel outside the active BWP. It is noted that a “cell”, a “carrier”, and the like in the present disclosure may be interchangeable with “BWP”.

It is noted that the structures of radio frames, subframes, slots, mini slots, symbols, and the like described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, and the like described in the present disclosure may be represented using absolute values, or may be represented using relative values with respect to given values, or may be represented using other corresponding information. For example, a radio resource may be instructed by a given index.

The names used for parameters and the like in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, and the like described in the present disclosure may be represented using any of a variety of different technologies. For example, data, an instruction, a command, information, a signal, a bit, a symbol, a chip, and the like, which may be referred to throughout the above description, may be represented by a voltage, a current, an electromagnetic wave, a magnetic field or a magnetic particle, an optical field or an optical photon, or any combination of these.

Information, signals, and the like can be output in at least one of a direction from a higher layer to a lower layer or a direction from a lower layer to a higher layer. Information, signals, and the like may be input and output via a plurality of network nodes.

Input and output information, signals, and the like may be stored in a specific location (for example, memory), or may be managed using a measurement table. The input/output information, signals, and the like can be overwritten, updated, or appended. The output information, signals, and the like may be deleted. Information, signals, and the like that have been input may be transmitted to another apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

It is noted that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC Connection Setup message, an RRC Connection Reconfiguration message, and the like. Further, notification of the MAC signaling may be performed using, for example, a MAC control element (CE).

Also, notification of given information (for example, notification of information to the effect that “X holds”) does not necessarily have to be sent explicitly, and can be sent implicitly (for example, by not notifying this given information, by reporting another piece of information, and the like).

Determination may be performed using a value represented by one bit (0 or 1), or may be performed using a Boolean represented by true or false, or may be performed by comparing numerical values (for example, comparison with a given value).

Software, regardless of whether it is referred to as software, firmware, middleware, microcode, or a hardware description language, or referred to by another name, should be interpreted broadly to mean an instruction, an instruction set, a code, a code segment, a program code, a program, a subprogram, a software module, an application, a software application, a software package, a routine, a subroutine, an object, an executable file, an execution thread, a procedure, a function, and the like.

Moreover, software, instructions, information, and the like may be transmitted and received via communication media. For example, when software is transmitted from a website, a server, or another remote source by using at least one of a wired technology (coaxial cable, optical fiber cable, twisted pair, digital subscriber line (DSL), or the like) and a wireless technology (infrared rays, microwaves, and the like), at least one of the wired technology and the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station and the base station subsystem that performs a communication service in this coverage.

In the present disclosure, the terms such as “mobile station (MS)”, “user terminal”, “user equipment (UE)”, and “terminal” can be used interchangeably.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

At least one of the base station and the mobile station may be referred to as a transmission apparatus, a reception apparatus, a radio communication apparatus, and the like. It is noted that at least one of the base station or the mobile station may be a device mounted on a moving body (moving object), a moving body itself, and the like.

The moving body refers to a movable object, the moving speed is arbitrary, and naturally includes a case in which the moving body is stopped. The moving body includes, for example, a vehicle, a transport vehicle, an automobile, a motorcycle, a bicycle, a connected car, an excavator, a bulldozer, a wheel loader, a dump truck, a forklift, a train, a bus, a rear car, a human-powered vehicle, a ship and other watercraft, an airplane, a rocket, an artificial satellite, a drone, a multicopter, a quadcopter, a balloon, and objects mounted thereon, and is not limited thereto. Further, the moving body may be a moving body that autonomously travels based on an operation command.

The moving body may be a transportation (for example, a car, an airplane, or the like), an unmanned moving body (for example, a drone, an autonomous car, or the like), or a (manned or unmanned) robot. It is noted that at least one of the base station and the mobile station also includes an apparatus that does not necessarily move during a communication operation. For example, at least one of the base station and the mobile station may be an Internet of Things (IoT) device such as a sensor.

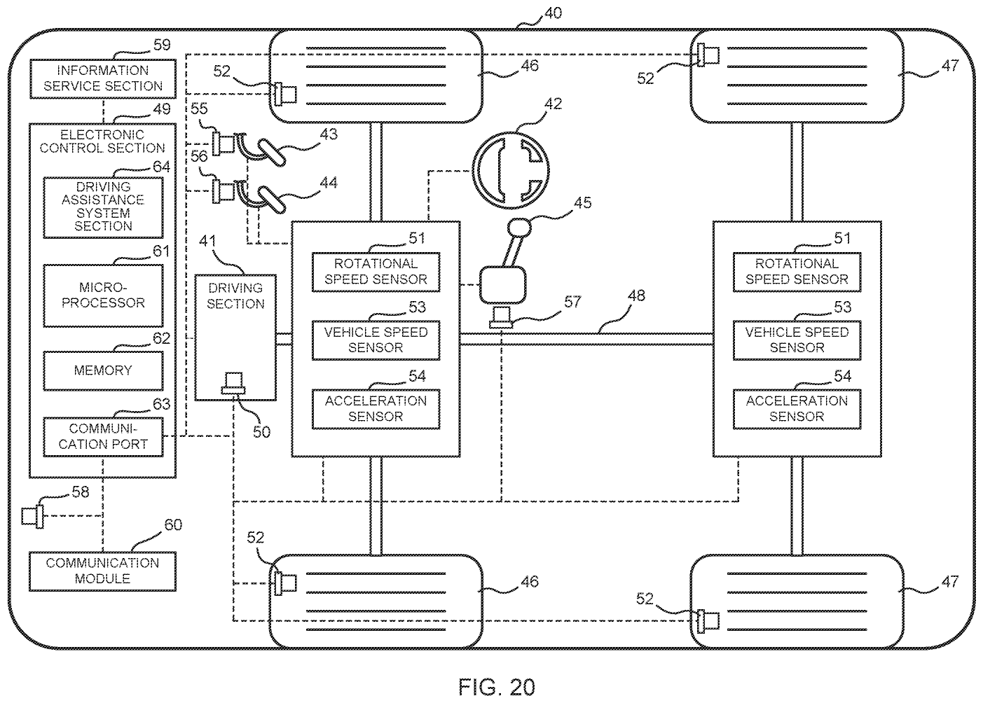

FIG. 20 is a diagram illustrating an example of a vehicle according to one embodiment. A vehicle 40 includes a drive unit 41, a steering unit 42, an accelerator pedal 43, a brake pedal 44, a shift lever 45, left and right front wheels 46, left and right rear wheels 47, an axle 48, an electronic control unit 49, various sensors (includes a current sensor 50, a rotation speed sensor 51, an air pressure sensor 52, a vehicle speed sensor 53, an acceleration sensor 54, an accelerator pedal sensor 55, a brake pedal sensor 56, a shift lever sensor 57, and an object detection sensor 58), an information service unit 59, and a communication module 60.

The drive unit 41 includes, for example, at least one of an engine, a motor, and a hybrid of an engine and a motor. The steering unit 42 includes at least a steering wheel (also referred to as a handle), and is configured to steer at least one of the front wheel 46 and the rear wheel 47 based on the operation of the steering wheel operated by a user.

The electronic control unit 49 includes a microprocessor 61, a memory (ROM, RAM) 62, and a communication port (for example, an input/output (IO) port) 63. Signals from the various sensors 50 to 58 provided in the vehicle are input to the electronic control unit 49. The electronic control unit 49 may be referred to as an electronic control unit (ECU).

The signals from the various sensors 50 to 58 include a current signal from the current sensor 50 that senses the current of the motor, a rotation speed signal of the front wheel 46/the rear wheel 47 acquired by the rotation speed sensor 51, an air pressure signal of the front wheel 46/the rear wheel 47 acquired by the air pressure sensor 52, a vehicle speed signal acquired by the vehicle speed sensor 53, an acceleration signal acquired by the acceleration sensor 54, a depression amount signal of the accelerator pedal 43 acquired by the accelerator pedal sensor 55, a depression amount signal of the brake pedal 44 acquired by the brake pedal sensor 56, an operation signal of the shift lever 45 acquired by the shift lever sensor 57, a detection signal for detecting an obstacle, a vehicle, a pedestrian, and the like acquired by the object detection sensor 58, and the like.

The information service unit 59 includes various devices for providing (outputting) various types of information such as driving information, traffic information, and entertainment information, such as a car navigation system, an audio system, a speaker, a display, a television, and a radio, and one or more ECUs that control these devices. The information service unit 59 provides various types of information/services (for example, multimedia information/multimedia services) to an occupant of the vehicle 40 using information acquired from an external device via the communication module 60 or the like.

The information service unit 59 may include an input device (for example, a keyboard, a mouse, a microphone, a switch, a button, a sensor, a touch panel, or the like) that receives an input from the outside, or may include an output device (for example, a display, a speaker, an LED lamp, a touch panel, or the like) that performs an output to the outside.

A driving assistance system unit 64 includes various devices for providing functions for preventing an accident in advance and reducing a driving load of a driver, such as a millimeter wave radar, light detection and ranging (LiDAR), a camera, a positioning locator (for example, global navigation satellite system (GNSS) or the like), map information (for example, a high definition (HD) map, an autonomous vehicle (AV) map, and the like), a gyro system (for example, an inertial measurement unit (IMU), an inertial navigation system (INS), or the like), an artificial intelligence (AI) chip, and an AI processor, and one or more ECUs for controlling these devices. Further, the driving assistance system unit 64 also transmits and receives various types of information via the communication module 60 so as to achieve a driving assistance function or an automatic driving function.

The communication module 60 can communicate with the microprocessor 61 and components of the vehicle 40 via the communication port 63. For example, the communication module 60 transmits and receives data (information) to and from the drive unit 41, the steering unit 42, the accelerator pedal 43, the brake pedal 44, the shift lever 45, the left and right front wheels 46, the left and right rear wheels 47, the axle 48, the microprocessor 61 and the memory (ROM, RAM) 62 in the electronic control unit 49, and the various sensors 50 to 58 provided in the vehicle 40 via the communication port 63.

The communication module 60 is a communication device that can be controlled by the microprocessor 61 of the electronic control unit 49 and can communicate with an external device. For example, various types of information are transmitted and received to and from an external device via radio communication. The communication module 60 may be either inside or outside the electronic control unit 49. The external device may be, for example, the base station 10, the user terminal 20, or the like described above. Furthermore, the communication module 60 may be, for example, at least one of the base station 10 and the user terminal 20 described above (may function as at least one of the base station 10 and the user terminal 20).

The communication module 60 may transmit at least one of the above-described signals from the various sensors 50 to 58 input to the electronic control unit 49, information obtained based on the signals, and information based on an input from the outside (user) obtained via the information service unit 59 to the external device via radio communication. The electronic control unit 49, the various sensors 50 to 58, the information service unit 59, and the like may be referred to as input units that receive inputs. For example, the PUSCH transmitted by the communication module 60 may include information based on the above input.

The communication module 60 receives various types of information (traffic information, traffic signal information, inter-vehicle information, and the like) transmitted from an external device, and displays the information on the information service unit 59 provided in the vehicle. The information service unit 59 may be referred to as an output unit that outputs information (for example, information is output to a device such as a display or a speaker based on a PDSCH (or data/information decoded from the PDSCH) received by the communication module 60).

The communication module 60 also stores various types of information received from external devices in the memory 62 available by the microprocessor 61. Based on the information stored in the memory 62, the microprocessor 61 may control the drive unit 41, the steering unit 42, the accelerator pedal 43, the brake pedal 44, the shift lever 45, the left and right front wheels 46, the left and right rear wheels 47, the axle 48, the various sensors 50 to 58, and the like provided in the vehicle 40.

The base station in the present disclosure may be interchangeable with a user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. In addition, the terms such as “uplink” and “downlink” may be interchangeable with terms corresponding to terminal-to-terminal communication (for example, “sidelink”). For example, an uplink channel, a downlink channel, and the like may be interchangeable with a sidelink channel.

Similarly, the user terminal in the present disclosure may be replaced with a base station. In the case, the base station 10 may have the function of the above-mentioned user terminal 20.

In the present disclosure, the operation performed by the base station may be performed by an upper node thereof in some cases. In a network including one or a plurality of network nodes with a base station, it is clear that various operations performed for communication with a terminal can be performed by a base station, one or more network nodes (for example, mobility management entity (MME) and serving-gateway (S-GW) are possible, but are not limitations) other than the base station, or a combination thereof.

Each aspect/embodiment described in the present disclosure may be used alone, used in combination, or switched in association with execution. Further, the order of processing procedures, sequences, flowcharts, and the like of the aspects/embodiments described in the present disclosure may be re-ordered as long as there is no inconsistency. For example, for the method described in the present disclosure, various step elements are presented by using an illustrative order, and the method is not limited to the presented specific order.

Each aspect/embodiment described in the present disclosure may be applied to a system using Long-Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (x is, for example, an integer or decimal)), Future Radio Access (FRA), New-Radio Access Technology (RAT), New Radio (NR), New radio access (NX), Future generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system extended, modified, generated, or prescribed based on those described above, and the like. Further, a plurality of systems may be combined (for example, a combination of LTE or LTE-A and 5G, and the like) and applied.

The phrase “based on” used in the present disclosure does not mean “based only on”, unless otherwise specified. In other words, the phrase “based on” means both “based only on” and “based at least on”.

Any reference to an element using designations such as “first” and “second” used in the present disclosure does not generally limit the amount or order of these elements. These designations can be used in the present disclosure, as a convenient way of distinguishing between two or more elements. In this way, reference to the first and second elements does not imply that only two elements may be employed, or that the first element must precede the second element in some way.

The term “determining” used in the present disclosure may include a wide variety of operations. For example, “determining” may be regarded as “determining” judging, calculating, computing, processing, deriving, investigating, looking up, search, inquiry (for example, looking up in table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

“Determining” may be interchangeable with “assuming”, “expecting”, “considering”, and the like.

The “maximum transmit power” described in the present disclosure may mean the maximum value of the transmit power, may mean the nominal UE maximum transmit power, or may mean the rated UE maximum transmit power.

The terms “connected” and “coupled” used in the present disclosure, or all variations thereof mean all direct or indirect connections or coupling between two or more elements, and can include the presence of one or more intermediate elements between two elements “connected” or “coupled” with each other. The coupling or connection between the elements may be physical, logical, or a combination of these. For example, the term “connection” is interchangeable with “access”.

In the present disclosure, when two elements are connected, the two elements can be considered to be “connected” or “coupled” with each other by using one or more electrical wires, cables, printed electrical connections, and the like, and using, as some non-limiting and non-inclusive examples, electromagnetic energy and the like having a wavelength in a radio frequency domain, a microwave domain, and an optical (both visible and invisible) domain.

In the present disclosure, the phrase “A and B are different” may mean “A and B are different from each other”. It is noted that the phrase may mean that “A and B are different from C”. The terms such as “leave”, “coupled”, and the like may be interpreted similarly to “different”.

In the present disclosure, when “include”, “including”, and variations thereof are used, these terms are intended to be inclusive similarly to the term “comprising”. The term “or” used in the present disclosure is intended not to be an exclusive-OR.

In the present disclosure, when articles in English such as “a”, “an”, and “the” are added in translation, the present disclosure may include the plural forms of nouns that follow these articles.

Although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined based on the description of claims. Consequently, the description of the present disclosure is provided only for the purpose of explaining examples, and should by no means be construed to limit the invention according to the present disclosure in any way.

The present application is based on Japanese Patent Application No. 2021-169153 filed on Oct. 14, 2021. The contents of the present application are all incorporated herein.

1. A terminal comprising:
a receiving section configured to receive a configuration related to a transmission comb of a sounding reference signal (SRS); and
a control section configured to determine, based on the configuration and a bandwidth of the SRS, at least one of the number of the transmission combs, a maximum number of cyclic shifts, and a number of the cyclic shift.

2. The terminal according to claim 1, wherein the number of the transmission combs and the maximum number of the cyclic shifts depend on the bandwidth.

3. The terminal according to claim 1, wherein the maximum number of the cyclic shifts does not depend on the bandwidth.

4. The terminal according to claim 2, wherein the number of the cyclic shift depends on the bandwidth.

5. A radio communication method of a terminal, the radio communication method comprising the steps of:
receiving a configuration related to a transmission comb of a sounding reference signal (SRS); and
determining, based on the configuration and a bandwidth of the SRS, at least one of the number of the transmission combs, a maximum number of cyclic shifts, and a number of the cyclic shift.

6. A base station comprising:
a transmitting section configured to transmit a configuration related to a transmission comb of a sounding reference signal (SRS); and
a control section configured to control reception of the SRS, wherein
at least one of the number of the transmission combs, a maximum number of cyclic shifts, and a number of the cyclic shift is determined based on the configuration and a bandwidth of the SRS.

7. The terminal according to claim 3, wherein the number of the cyclic shift depends on the bandwidth.
